(19) United States
(12) Patent Application Publication
(10) Pub. No.: US 2025/0227586 A1
(43) Pub. Date: Jul. 10, 2025

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/092,607

(22) Filed: Mar. 27, 2025

Related U.S. Application Data
(63) Continuation of application No. PCT/JP2023/034429, filed on Sep. 22, 2023.
(60) Provisional application No. 63/410,710, filed on Sep. 28, 2022.

(51) Int. Cl. H04W 36/08

(52) U.S. Cl. CPC H04W 36/08

(57) ABSTRACT

In an aspect, a communication control method is used in a cellular communication system. The communication control method includes transmitting, by a distributed unit (DU) to a central unit (CU), resource information regarding a resource used in a user equipment during an RACH-less handover, and transmitting, by the central unit to the user equipment, a handover command including the resource information.

### RELATED APPLICATIONS

The present application is a continuation based on PCT Application No. PCT/JP2023/034429, filed on Sep. 22, 2023, which claims the benefit of U.S. Provisional Patent Application No. 63/410,710 filed on Sep. 28, 2022. The content of which is incorporated by reference herein in their entirety.

### TECHNICAL FIELD

The present disclosure relates to a communication control method used in a cellular communication system.

### BACKGROUND

The third generation partnership project (3GPP), which is a standardization project of a cellular communication system, has studied the introduction of a new relay node referred to as an Integrated Access and Backhaul (IAB) node (for example, see Non-Patent Document 1). One or more relay nodes are involved in communication between a base station and a user equipment and perform relay for the communication.

### CITATION LIST

### Non-Patent Literature

Non-Patent Document 1: 3GPP TS 38.300 V17.1.0 (2022 June)

### SUMMARY

In a first aspect, a communication control method is used in a cellular communication system. The communication control method includes transmitting, by a distributed unit (DU) to a central unit (CU), resource information regarding a resource used in a user equipment during an RACH-less handover, and transmitting, by the central unit to the user equipment, a handover command including the resource information.

In a second aspect, a communication control method is used in a cellular communication system. The communication control method includes either transmitting, by a central unit (CU) to a distributed unit (DU), validity period information indicating a validity period of a resource used in a user equipment during a conditional RACH-less handover, or transmitting, by the distributed unit to the central unit, the validity period information. The communication control method also includes transmitting, by the central unit to the user equipment, a conditional reconfiguration including the validity period information.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a UE (user equipment) according to the embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIGS. 9A and 9B are diagrams illustrating an example of full migration according to a first embodiment.

FIGS. 10A and 10B are diagrams illustrating an example of full migration according to the first embodiment.

FIG. 11 is a diagram illustrating an example of a relationship between a CU, a DU, and UE according to the first embodiment.

FIGS. 12A and 12B are diagrams illustrating an example of a relationship between a CU, a DU, and UE according to the first embodiment.

FIGS. 13A and 13B are diagrams illustrating an example of a relationship between a CU, a DU, and UE according to the first embodiment.

FIG. 14 is a diagram illustrating an operation example according to the first embodiment.

FIG. 15 is a diagram illustrating an operation example according to a second embodiment.

FIG. 16 illustrates RACH-less handover using a timing advance (TA) value and/or a UL grant.

FIG. 17 illustrates scenarios and subcases for UE cell reselection.

FIG. 18 illustrates scenarios for PCI collision.

### DESCRIPTION OF EMBODIMENTS

A cellular communication system according to an embodiment will be described with reference to the drawings. In the description of the drawings, the same or similar parts are denoted by the same or similar reference signs.

### First Embodiment

### Configuration of Cellular Communication System

A configuration example of the cellular communication system according to an embodiment is described. A cellular communication system 1 according to an embodiment is a 3GPP 5G system. Specifically, a radio access scheme in the cellular communication system 1 is a new radio (NR) being a 5G radio access scheme. Note that long term evolution (LTE) may be at least partially applied to the cellular communication system 1. A future cellular communication system such as 6G may be applied to the cellular communication system 1.

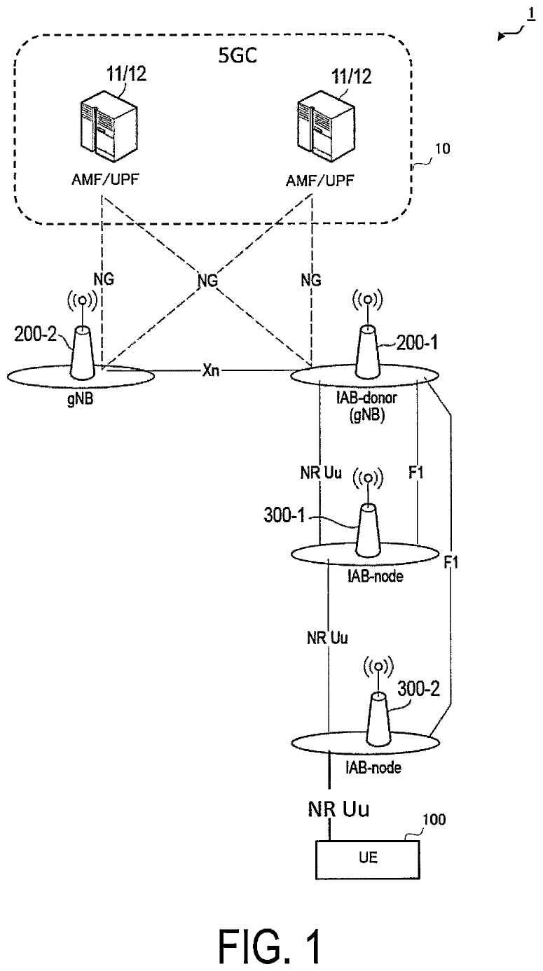

FIG. 1 is a diagram illustrating a configuration example of the cellular communication system 1 according to the embodiment.

As shown in FIG. 1, the cellular communication system 1 includes a 5G core network (5GC) 10, a user equipment (UE) 100, base station devices (hereinafter may be referred to as “base stations”) 200-1 and 200-2, and IAB nodes 300-1 and 300-2. The base station 200 may be referred to as a gNB.

In the following, an example in which the base station 200 is an NR base station will be mainly described, but the base station 200 may also be an LTE base station (that is, an eNB).

In the following, the base stations 200-1 and 200-2 may be referred to as gNBs 200 (or base station 200), and the IAB nodes 300-1 and 300-2 may be referred to as IAB nodes 300.

The 5GC 10 includes an access and mobility management function (AMF) 11 and a user plane function (UPF) 12. The AMF 11 is a device that performs various mobility controls for the UE 100. The AMF 11 communicates with the UE 100 using non-access stratum (NAS) signaling to manage information on an area in which the UE 100 exists. The UPF 12 is a device that performs transfer control of user data, and the like.

Each gNB 200 is a fixed radio communication node and manages one or more cells. The term “cell” is used to indicate a minimum unit of a radio communication area. The term “cell” may be used to indicate a function or resource for performing radio communication with the UE 100. One cell belongs to one carrier frequency. Hereinafter, a cell and a base station may be used without distinction.

Each gNB 200 is interconnected with the 5GC 10 via an interface referred to as an NG interface. FIG. 1 illustrates two gNBs, that is, a gNB 200-1 and a gNB 200-2, connected to the 5GC 10.

Each gNB 200 may be divided into a central unit (CU) and a distributed unit (DU). The CU and the DU are interconnected via an interface referred to as an F1 interface. An F1 protocol is a communication protocol between the CU and the DU, and includes an F1-C protocol, which is a control plane protocol, and an F1-U protocol, which is a user plane protocol.

The cellular communication system 1 supports IAB, which enables radio relay of NR access using an NR for backhaul. The donor gNB 200-1 (or donor node; hereinafter may be referred to as “donor node”) is a terminal node of the NR backhaul on the network side, and is a donor base station having additional functions for supporting IAB. The backhaul is capable of multi-hopping via a plurality of hops (that is, a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted by two backhaul hops.

The UE 100 is a mobile radio communication device that performs radio communication with a cell. The UE 100 may be any device that performs radio communication with the gNB 200 or the IAB node 300. For example, the UE 100 is a mobile phone terminal and/or a tablet terminal, a laptop PC, a sensor, a device provided in a sensor, a vehicle, a device provided in a vehicle, an aircraft, or a device provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

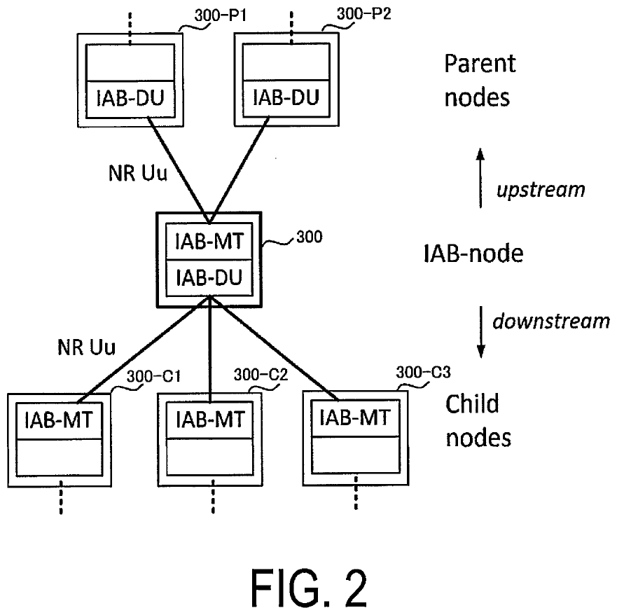

FIG. 2 is a diagram illustrating an example of a relationship between the IAB node 300, parent nodes, and child nodes.

As illustrated in FIG. 2, each IAB node 300 includes an IAB-DU equivalent to a base station function unit and an IAB-MT (Mobile Termination) equivalent to a user equipment function unit.

Adjacent nodes (that is, upper nodes) on an NR Uu radio interface of the IAB-MT are referred to as parent nodes. The parent node is a DU of a parent IAB node or the donor node 200. A radio link between the IAB-MT and the parent node is referred to as a backhaul link (BH link). FIG. 2 illustrates an example in which the parent nodes of the IAB node 300 are IAB nodes 300-P1 and 300-P2. A direction toward the parent nodes is referred to as upstream. From the perspective of the UE 100, the upper node of the UE 100 may correspond to a parent node.

Adjacent nodes (that is, lower nodes) on the NR access interface of the IAB-DU are referred to as child nodes. The IAB-DU manages the cell, similar to the gNB 200. The IAB-DU terminates the NR Uu radio interface to the UE 100 and the lower IAB nodes. The IAB-DU supports the F1 protocol to the CU of the donor node 200-1. FIG. 2 illustrates an example in which the child nodes of the IAB node 300 are IAB nodes 300-C1 to 300-C3, but the child node of the IAB node 300 may also include the UE 100. A direction toward the child nodes is referred to as downstream.

All of the IAB nodes 300 connected to the donor node 200 via one or more hops form a directed acyclic graph (DAG) topology (hereinafter may be referred to as “topology”) with the donor node 200 as the root. In this topology, as illustrated in FIG. 2, adjacent nodes on the IAB-DU interface are child nodes, and adjacent nodes on the IAB-MT interface are parent nodes. The donor node 200 performs central management including resource, topology, and route management of the IAB topology. The donor node 200 is a gNB that provides network access to the UE 100 via a network of backhaul links and access links.

### Configuration of Base Station

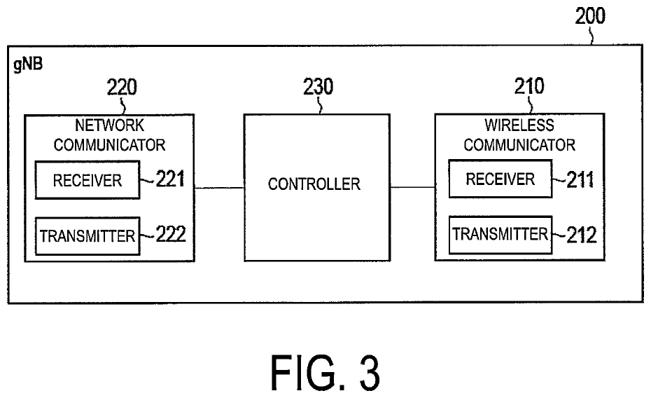

The configuration of the gNB 200, which is a base station according to the embodiment, will be described. FIG. 3 is a diagram illustrating a configuration example of the gNB 200. As illustrated in FIG. 3, the gNB 200 includes a radio communicator 210, a network communicator 220, and a controller 230.

The radio communicator 210 performs radio communication with the UE 100 and the IAB node 300. The radio communicator 210 includes a receiver 211 and a transmitter 212. The receiver 211 performs various types of reception under the control of the controller 230. The receiver 211 includes an antenna, and converts (down-converts) a radio signal received by the antenna into a baseband signal (reception signal) and outputs the signal to the controller 230. The transmitter 212 performs various types of transmission under the control of the controller 230. The transmitter 212 includes an antenna, and converts (up-converts) a baseband signal (transmission signal) output by the controller 230 into a radio signal and transmits the signal from the antenna.

The network communicator 220 performs wired communication (or radio communication) with the 5GC 10 and wired communication (or radio communication) with other adjacent gNBs 200. The network communicator 220 includes a receiver 221 and a transmitter 222. The receiver 221 performs various types of reception under the control of the controller 230. The receiver 221 receives a signal from the outside and outputs the reception signal to the controller 230. The transmitter 222 performs various types of transmission under the control of the controller 230. The transmitter 222 transmits a transmission signal output by the controller 230 to the outside.

The controller 230 performs various types of control for the gNB 200. The controller 230 includes at least one memory and at least one processor electrically connected to the memory. The memory stores a program to be executed by the processor and information to be used for processing performed by the processor. The processor may include a baseband processor and a CPU. The baseband processor performs modulation, demodulation, coding, decoding, and the like of a baseband signal. The CPU executes the program stored in the memory to thereby perform various types of processing. The processor performs processing of layers to be described below. The controller 230 may perform all of the processing and operations in the gNB 200 in each embodiment to be described below.

### Configuration of Relay Node

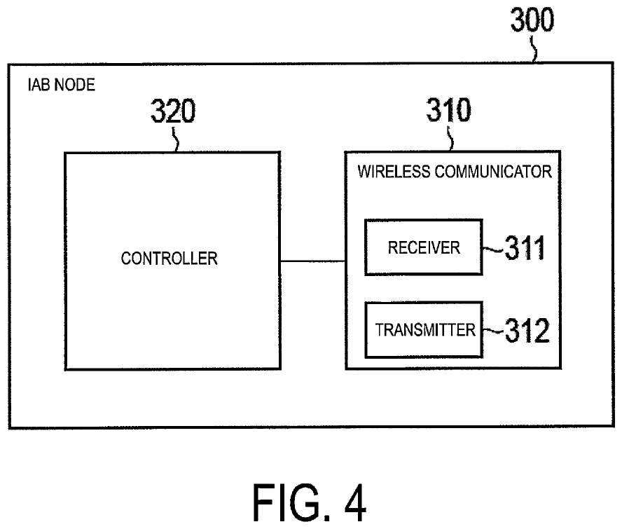

A configuration of the IAB node 300 that is a relay node (or a relay node apparatus, which may hereinafter be referred to as a “relay node”) according to the embodiment will be described. FIG. 4 is a diagram illustrating a configuration example of the IAB node 300. As illustrated in FIG. 4, the IAB node 300 includes a radio communicator 310 and a controller 320. The IAB node 300 may include a plurality of radio communicators 310.

The radio communicator 310 performs radio communication (BH link) with the gNB 200 and radio communication (access link) with the UE 100. The radio communicator 310 for BH link communication and the radio communicator 310 for access link communication may be provided separately.

The radio communicator 310 includes a receiver 311 and a transmitter 312. The receiver 311 performs various types of reception under the control of the controller 320. The receiver 311 includes an antenna, and converts (down-converts) a radio signal received by the antenna into a baseband signal (reception signal) and outputs the converted signal to the controller 320. The transmitter 312 performs various types of transmission under the control of the controller 320. The transmitter 312 includes an antenna, and converts (up-converts) a baseband signal (transmission signal) output by the controller 320 into a radio signal and transmits the converted signal from the antenna.

The controller 320 performs various types of control in the IAB node 300. The controller 320 includes at least one memory and at least one processor electrically connected to the memory. The memory stores programs executed by the processor and information used in processing performed by the processor. The processor may include a baseband processor and a CPU. The baseband processor performs modulation, demodulation, coding, decoding, and the like of a baseband signal. The CPU executes the program stored in the memory to thereby perform various types of processing. The processor performs processing of layers to be described below. The controller 320 may perform each process or each operation in the IAB node 300 in each embodiment to be described below.

### Configuration of User Equipment

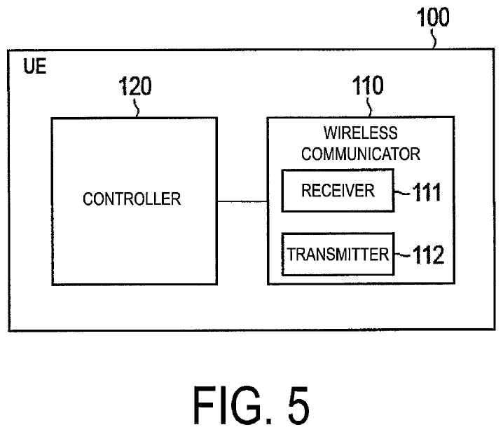

The configuration of the UE 100, which is a user equipment according to the embodiment, will be described. FIG. 5 is a diagram illustrating a configuration example of the UE 100. As illustrated in FIG. 5, the UE 100 includes a radio communicator 110 and a controller 120.

The radio communicator 110 performs radio communication in an access link, that is, radio communication with the gNB 200 and radio communication with the IAB node 300. The radio communicator 110 may also perform radio communication in a side link, that is, radio communication with other UEs 100. The radio communicator 110 includes a receiver 111 and a transmitter 112. The receiver 111 performs various types of reception under the control of the controller 120. The receiver 111 includes an antenna, and converts (down-converts) a radio signal received by the antenna into a baseband signal (reception signal) and outputs the converted signal to the controller 120. The transmitter 112 performs various types of transmission under the control of the controller 120. The transmitter 112 includes an antenna, and converts (up-converts) a baseband signal (transmission signal) output by the controller 120 into a radio signal and transmits the converted signal from the antenna.

The controller 120 performs various types of control in the UE 100. The controller 120 includes at least one memory and at least one processor electrically connected to the memory. The memory stores a program to be executed by the processor and information to be used for processing performed by the processor. The processor may include a baseband processor and a CPU. The baseband processor performs modulation, demodulation, coding, decoding, and the like of a baseband signal. The CPU executes the program stored in the memory to thereby perform various types of processing. The processor performs processing of layers to be described below. The controller 120 may perform each process in the UE 100 in each embodiment to be described below.

### Configuration of Protocol Stack

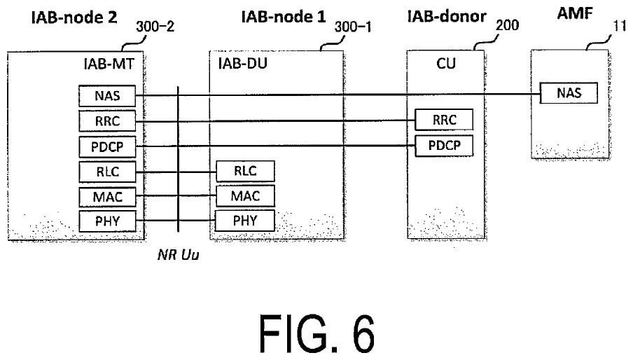

A configuration of a protocol stack according to the embodiment will be described. FIG. 6 is a diagram illustrating an example of a protocol stack related to RRC connection and NAS connection of the IAB-MT.

As illustrated in FIG. 6, the IAB-MT of the IAB node 300-2 includes a physical (PHY) layer, a medium access control (MAC) layer, a radio link control (RLC) layer, a packet data convergence protocol (PDCP) layer, a radio resource control (RRC) layer, and a non-access stratum (NAS) layer.

The PHY layer performs coding, decoding, modulation, demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines a transport format (transport block size, modulation and coding scheme (MCS)) and assigned resource blocks for an uplink and a downlink.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression/decompression and encryption/decryption. Data and control information are transmitted between the PDCP layer of the IAB-MT of the IAB node 300-2 and the PDCP layer of the donor node 200 via a radio bearer.

The RRC layer controls the logical channel, the transport channel, and he physical channel in accordance with establishment, re-establishment, and release of the radio bearer. RRC signaling for various settings is transmitted between the RRC layer of the IAB-MT of the IAB node 300-2 and the RRC layer of the donor node 200. When an RRC connection with the donor node 200 is present, the IAB-MT is in an RRC connected state. When no RRC connection with the donor node 200 is present, the IAB-MT is in an RRC idle state.

The NAS layer positioned at an upper layer of the RRC layer performs session management, mobility management, and the like. NAS signaling is transmitted between the NAS layer of the IAB-MT of the IAB node 300-2 and the AMF 11.

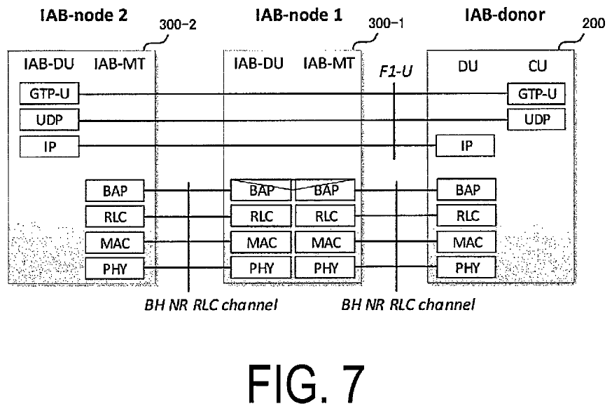

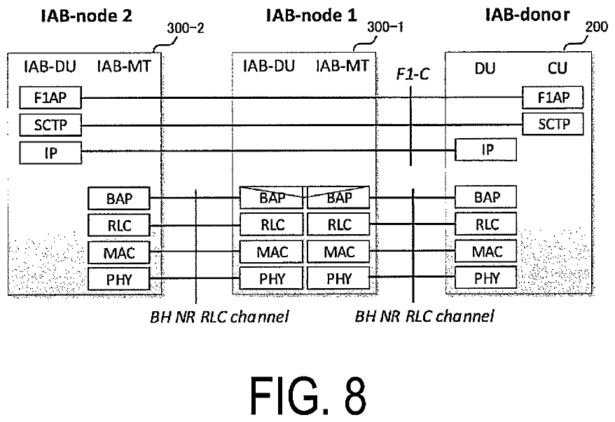

FIG. 7 is a diagram illustrating a protocol stack related to the F1-U protocol. FIG. 8 is a diagram illustrating a protocol stack related to the F1-C protocol. Here, an example in which the donor node 200 is divided into a CU and a DU is shown.

As illustrated in FIG. 7, the IAB-MT of the IAB node 300-2, the IAB-DU of the IAB node 300-1, the IAB-MT of the IAB node 300-1, and the DU of the donor node 200 each includes a backhaul adaptation protocol (BAP) layer as an upper layer of the RLC layer. The BAP layer is a layer for performing a routing process and a bearer mapping/demapping process. In the backhaul, the IP layer is transmitted via the BAP layer, which allows routing by a plurality of hops.

In each backhaul link, a protocol data unit (PDU) of the BAP layer is transmitted by a backhaul RLC channel (BH NR RLC channel). A plurality of backhaul RLC channels are configured in each BH link, thus enabling traffic prioritization and quality of service (QOS) control. The PDU of the BAP is associated with the backhaul RLC channel by the BAP layer of each IAB node 300 and the BAP layer of the donor node 200.

As illustrated in FIG. 8, the protocol stack of the F1-C protocol includes an F1AP layer and an SCTP layer instead of a GTP-U layer and an UDP layer illustrated in FIG. 7.

In the following, processes or operations performed in the IAB-DU and IAB-MT of the IAB may be simply described as processes or operations of the “IAB”. For example, the transmission of a message of the BAP layer to the IAB-MT of the IAB node 300-2 by the IAB-DU of the IAB node 300-1 will be described as the transmission of the message to the IAB node 300-2 by the IAB node 300-1. Processes or operations of the DU or CU of the donor node 200 may also be described simply as processes or operations of the “donor node.”

An upstream direction and an uplink (UL) direction may be used without distinction. A downstream direction and a downlink (DL) direction may be used without distinction.

### Mobile IAB Node

At present, 3GPP has started to study the introduction of a mobile IAB node. The mobile IAB node is, for example, a mobile IAB node. The mobile IAB node may be a movable IAB node. The mobile IAB node may be an IAB node that is capable of moving. The mobile IAB node may be an IAB node that is currently stationary but is certain to move in the future (or is expected to move in the future).

The mobile IAB node allows, for example, the UE 100 under the control of the mobile IAB node to receive services from the mobile IAB node while moving in accordance with the movement of the mobile IAB node. For example, a case is assumed in which a user (or UE 100) who is getting on a vehicle receives services via a mobile IAB node installed in the vehicle.

On the other hand, in contrast to the mobile IAB node, an IAB node that does not move also exists. Such an IAB node may be referred to as an intermediate IAB node. The intermediate IAB node is, for example, an IAB node that does not move. The intermediate IAB node may be a stationary IAB node. The intermediate IAB node may be a stationary IAB node. The intermediate IAB node may be an IAB node that is stationary (or does not move) in a state of being installed at its installation location. The intermediate IAB node may be a stationary IAB node that does not move. The intermediate IAB node may be a fixed IAB node.

The mobile IAB node can also be connected to the intermediate IAB node. The mobile IAB node can also be connected to the donor node 200. The mobile IAB node can also change its connection destination due to its movement (migration or handover). A connection source may be the intermediate IAB node. The connection source may be the donor node 200. The connection destination may be the intermediate IAB node. The connection destination may be the donor node 200.

In the following, the migration of the mobile IAB node and the handover of the mobile IAB node may be used without distinction.

In the following, the mobile IAB node may be a “mobile IAB node”. The mobile IAB node may be a “migrating IAB node”. In either case, the node may be referred to as a mobile IAB node.

### Full Migration of Mobile IAB Node

The mobile IAB node may move between the donor nodes (IAB-donors) 200.

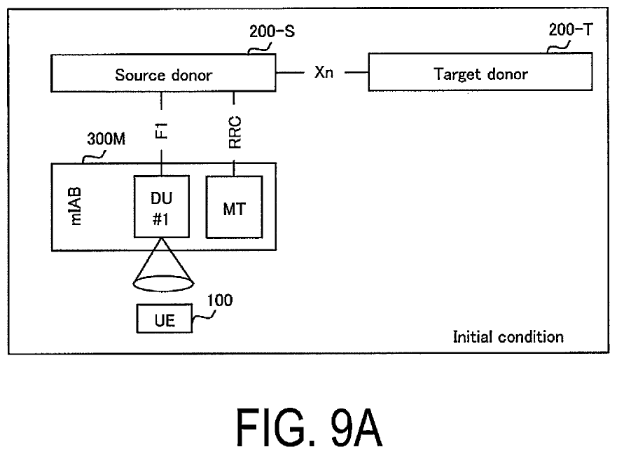

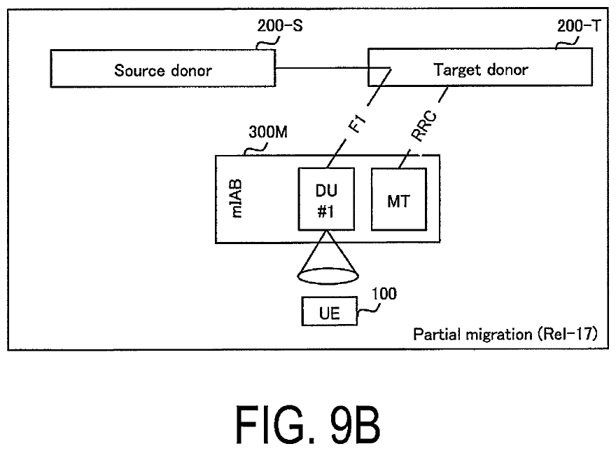

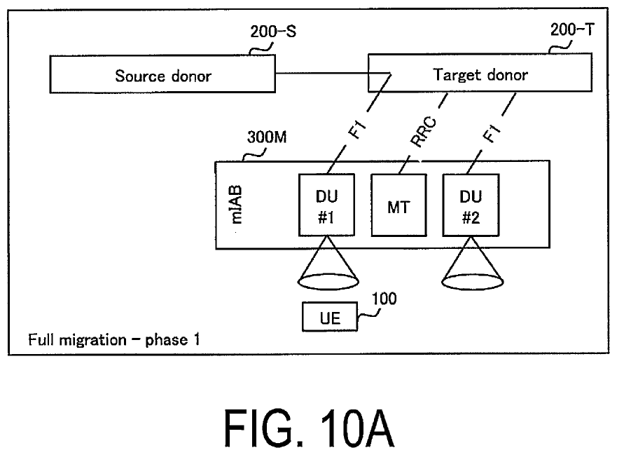

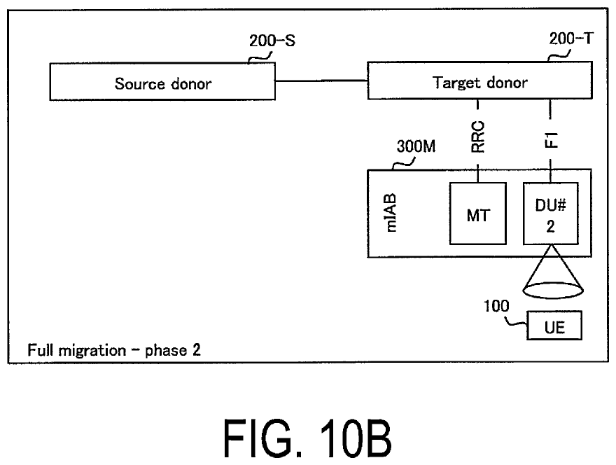

FIGS. 9A to 10B are diagrams illustrating an example of a procedure when a mobile IAB node 300M moves from a source donor node 200-S to a target donor node 200-T. The mobile IAB node 300M accommodates the UE 100 under its control. FIG. 9A illustrates an example in which the UE 100 exists in a cell range formed by an IAB-DU #1 of the mobile IAB node 300M. The UE 100 can move together with the mobile IAB node 300M.

FIG. 9A illustrates an example of an initial condition. The IAB-DU #1 of the mobile IAB node 300M has established an F1 connection with the CU of the source donor node 200-S. The IAB-MT of the mobile IAB node 300M has also established an RRC connection with the CU of the source donor node 200-S.

FIG. 9B illustrates an example of a case where the mobile IAB node 300M has moved to the target donor node 200-T, resulting in a state of partial migration with respect to the target donor node 200-T. As illustrated in FIG. 9B, in the partial migration, the IAB-DU #1 (and UE 100) of the mobile IAB node 300M is terminated in the CU of the source donor node 200-S, while the IAB-MT of the mobile IAB node 300M has moved to the CU of the target donor node 200-T. The IAB-MT of the mobile IAB node 300M has established an RRC connection with the CU of the target donor node 200-T. The IAB-DU of the mobile IAB node 300M has established an F1 connection with the source donor node 200-S. The partial migration refers to, for example, a state in which the connection of the UE 100 under the control of the mobile IAB node 300M remains in the source donor node 200-S via the IAB-DU #1 of the mobile IAB node 300M.

FIG. 10A illustrates an example of a case where the mobile IAB node 300M subsequently enters a state of a phase 1 of full migration with respect to the target donor node 200-T. In the phase 1 of the full migration, the UE 100 remains connected to the source donor node 200-S via the IAB-DU #1, but a new IAB-DU #2 has established an F1 connection with the CU of the target donor node 200-T. Here, the IAB-DU #1 and the IAB-DU #2 may be logical IAB-DUs. One physical IAB-DU may include two logical IAB-DUs (IAB-DU #1 and IAB-DU #2).

FIG. 10B illustrates an example of a case where the mobile IAB node 300M subsequently enters a state of a phase 2 of full migration with respect to the target donor node 200-T. In the phase 2 of the full migration, the connection of the mobile IAB node 300M (and UE 100) has moved from the CU of the source donor node 200-S to the CU of the target donor node 200-T. The full migration refers to, for example, a state in which the connection of the UE 100 has moved to the target donor node 200-T via the IAB-DU #2 of the mobile IAB node 300M.

In addition, movement between CUs using two DUs (IAB-DU #1 and IAB-DU #2) by the mobile IAB node 300M may be referred to as “dual DU approach.” For example, the dual DU approach is performed when the UE 100 moves from one CU and DU to the other CU and DU.

### RACH-Less Handover

In 3GPP, an RACH-less handover (RACH-less HO) (for example, 3GPP TS 36.300 V17.1.0 (2022-06)) is specified. The RACH-less handover is a handover that skips a random access procedure. In an RACH-less handover in an LTE system, for example, the following process is performed.

That is, the UE 100 receives an RRC connection reconfiguration message from a source cell. The RRC connection reconfiguration message includes an information element (MobilityControlInfo) including parameters (such as a timing advance (TA) value and/or a UL grant) used when the UE 100 performs an RACH-less handover. The UE 100 transmits an RRC connection reconfiguration complete (RRCConnectionReconfigurationComplete) message to a target cell without performing a random access (RACH) procedure by using the parameters included in the RRC connection reconfiguration message. As described above, the RACH-less handover is performed, and the UE 100 can establish uplink synchronization with the target cell.

In the RACH-less handover, the random access procedure is skipped, and thus a delay in an execution time of the handover can be improved compared to a case where the random access procedure is executed in the UE 100.

### Communication Control Method According to First Embodiment

The UE 100 under the control of the mobile IAB node 300M may perform an RACH-less handover. For example, in full migration of the mobile IAB node 300M, the UE 100 changes its connection destination from the IAB-DU #1 (or the cell formed by the IAB-DU #1; that is, the source cell) of the mobile IAB node 300M to the IAB-DU #2 (or the cell formed by the IAB-DU #2; that is, the target cell) (see FIGS. 10A and 10B). For this reason, the UE 100 performs a handover from the IAB-DU #1 to the IAB-DU #2. However, the IAB-DU #1 and the IAB-DU #2 are logical DUs and may be physically the same DU. That is, when two DUs (or two cells) are provided using the same antenna system, a physical distance between the UE 100 and the antenna system is the same, and thus TA values can also be regarded as being the same. Thus, when the UE 100 performs a handover from the IAB-DU #1 to the IAB-DU #2, the UE 100 can avoid connection interruptions and the like by performing an RACH-less handover rather than executing a random access procedure for the IAB-DU #2, thereby allowing the UE 100 to perform communication appropriately.

On the other hand, in the 5G system, the UE 100 can complete the RACH-less handover by transmitting an RRC reconfiguration complete (RRCReconfigurationComplete) message. In the 5G system, the RRC reconfiguration complete message is used instead of the RRC connection reconfiguration complete (RRCConnectionReconfigurationComplete) message in the LTE system.

In general, uplink resource information (that is, UL grant) is configured by a DU using downlink control information (DCI). On the other hand, an RACH-less handover is configured using an RRC reconfiguration message, and is thus configured by a CU. That is, the UL grant is configured by the DU, and the RACH-less handover is configured by the CU. When the CU does not have information regarding the UL grant, it may not be able to appropriately configure an RACH-less handover for the UE 100. In this case, the UE 100 cannot transmit an RRC reconfiguration complete message and cannot appropriately execute an RACH-less handover.

An object of the first embodiment is for the UE 100 to appropriately execute an RACH-less handover.

For this reason, in the first embodiment, first, the distributed unit (DU) transmits resource information regarding resources used in the user equipment (for example, UE 100) during an RACH-less handover to the central unit (CU). Second, the central unit transmits a handover command including the resource information to the user equipment.

In this manner, the resource information used by the UE 100 during the RACH-less handover is transmitted from the DU to the CU, and thus the CU can appropriately configure an RACH-less handover for the UE 100 by using the resource information. Thus, the UE 100 can appropriately execute the RACH-less handover.

### Relationship Between CU, DU, and UE 100

Here, an example of a relationship between the CU, the DU, and the UE 100 when an RACH-less handover is performed is described. The CU may be a central unit, and the DU may be a distributed unit.

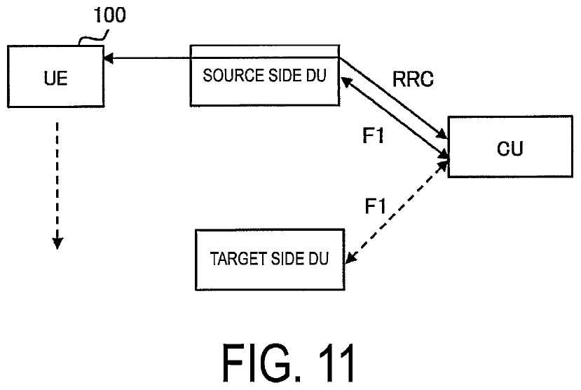

FIG. 11 is a diagram illustrating an example of a relationship between the CU, the DU, and the UE 100 according to the first embodiment. In general, as illustrated in FIG. 11, when the UE 100 moves from a source side DU (or a source cell formed by the source side DU) to a target side DU (or a target cell formed by the target side DU), the UE 100 executes a handover (RACH-less handover in the first embodiment) for the target side DU which is a movement destination.

The relationship between the CU, the DU, and the UE 100 can be classified into, for example, the following two cases.

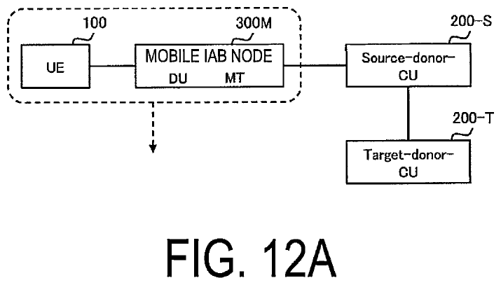

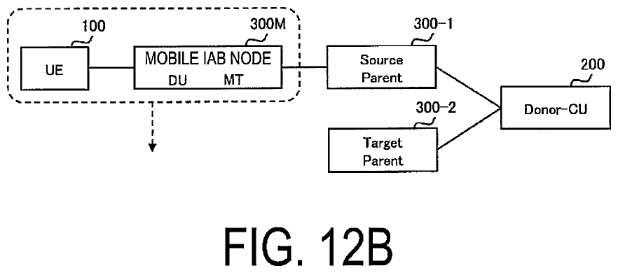

First, the donor node 200 includes the CU, and the mobile IAB node 300M includes the DU. That is, the CU is the CU (IAB-donor-CU) of the donor node 200, and the DU is the IAB-DU of the mobile IAB node 300M. FIGS. 12A and 12B illustrate examples of a relationship in such a case. FIG. 12A illustrates an example of inter-donor migration, and FIG. 12B illustrates an example of intra-donor migration. The mobile IAB node 300M may be a fixed IAB node.

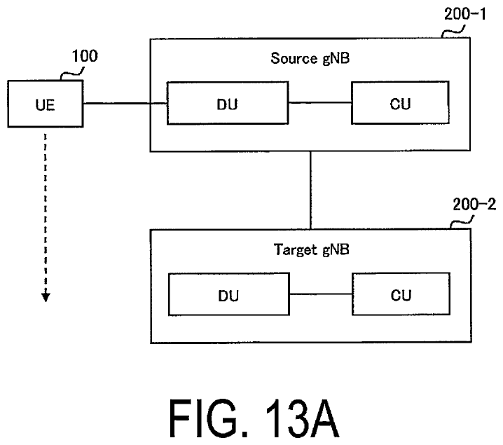

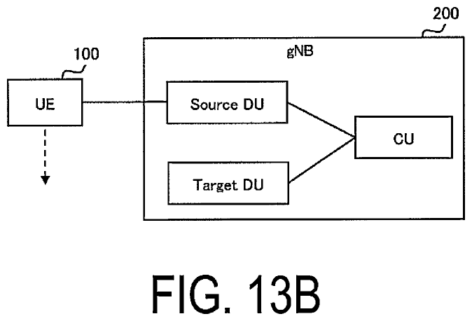

Second, the gNB 200 includes the CU and the DU. That is, the CU is a CU of the gNB 200, and the DU is a DU of the gNB 200. FIGS. 13A and 13B illustrate examples of a relationship in such a case. FIG. 13A illustrates an example of an inter-gNB handover (Inter-gNB HO), and FIG. 13B illustrates an example of an intra-gNB handover (Intra-gNB HO). The source cell and the target cell may be provided from the same DU. Such a handover is referred to as an intra-DU handover (Intra-DU HO).

In addition, the IAB-MT of the mobile IAB node 300M has a UE function in the mobile IAB node. For this reason, the mobile IAB node 300M itself may perform an RACH-less handover for the donor node 200. In this case, in FIGS. 13A and 13B, the UE 100 can be read as the mobile IAB node 300M, and the gNB 200 can be read as the donor node 200.

In operation examples to be shown below, description may be given mainly using an example of inter-donor migration illustrated in FIG. 12A (or full migration illustrated in FIGS. 9A to 10B).

### Operation Example According to First Embodiment

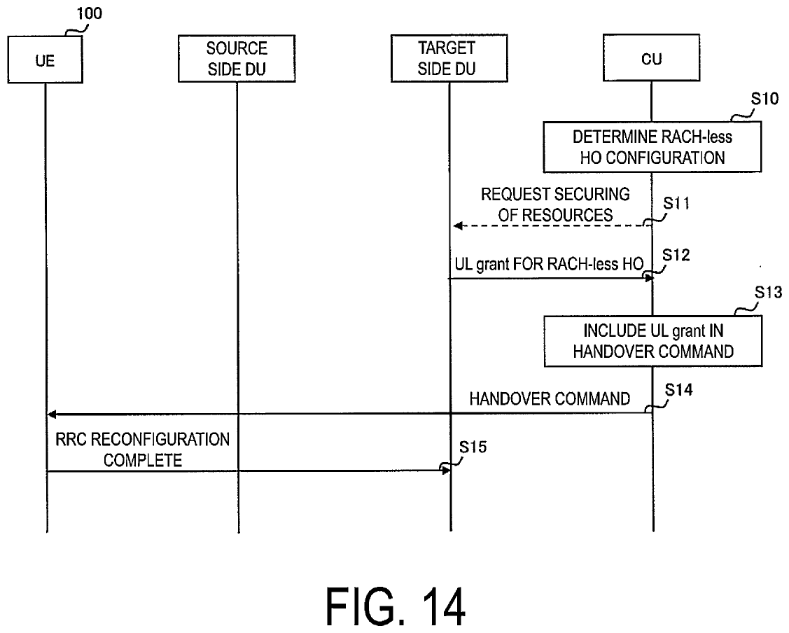

FIG. 14 is a flowchart illustrating an operation example according to the first embodiment.

As illustrated in FIG. 14, in step S10, the CU determines to configure an RACH-less handover for the UE 100. For example, the CU of the target donor node 200-T determines to configure an RACH-less handover for the UE 100 under the control of the mobile IAB node 300M because the mobile IAB node 300M moves. Alternatively, the CU of the source donor node 200-S may notify the CU of the target donor node 200-T, using an Xn message, that an RACH-less handover can be configured for the UE 100 under the control of the mobile IAB node 300M because the mobile IAB node 300M moves.

In step S11, the CU may request the DU (the DU providing the target cell) to secure resources (or UL resources) for an RACH-less handover. The CU may make a request by transmitting a resource securing request message for requesting the securing of resources for an RACH-less handover. For example, when the CU of the target donor node 200-T has established an F1 connection with the target side DU (the IAB-DU #2 of the mobile IAB node 300M in the example of FIG. 10A), the CU transmits the resource securing request message to the target side DU as an F1 message. The resource securing request message may be a message for requesting the allocation of an UL grant for an RACH-less handover. The resource securing request message may be a message for requesting the provision of resource information (or UL grant information) for an RACH-less handover allocated by the DU. The resource securing request message may be a message for requesting UE Context Setup and may include an identifier indicating an RACH-less handover. The resource securing request message may include a setting value desired by the CU (or a setting value to be included in an RRC reconfiguration message).

In step S12, the DU transmits UL grant information for an RACH-less handover to the CU. The UL grant information represents, for example, resource information regarding resources used in the UE 100 during an RACH-less handover. The DU may transmit the UL grant information for an RACH-less handover by transmitting a resource information message including the UL grant information for an RACH-less handover to the CU. For example, when the target side DU (the IAB-DU #2 of the mobile IAB node 300M in the example of FIG. 10A) has established an F1 connection with the CU of the target donor node 200-T, the target side DU transmits the resource information message including the UL grant information to the CU of the target donor node 200-T as an F1 message. The UL grant information included in the resource information message may be UL resource configuration information. The information may be physical uplink shared channel (PUSCH) resource configuration information.

In step S13, the CU includes the UL grant information for an RACH-less handover in a handover command. The handover command may be an RRC reconfiguration (RRCReconfiguration) message including an information element (for example, reconfiguration with synch (reconfigurationWithSync)) used by the UE 100 to establish synchronization with a target cell during a handover. The UL grant information for an RACH-less handover may be included in the reconfiguration WithSynch. For example, the CU of the target donor node 200-T includes the UL grant information in the handover command.

In step S14, the CU transmits the handover command to the UE 100. For example, the CU of the target donor node 200-T transmits an Xn message including the handover command to the CU of source donor node 200-S, and the CU of the source donor node 200-S transmits the handover command to the UE 100. In this case, the CU of the source donor node 200-S extracts the handover command from the Xn message and transmits the F1 message including the handover command to the source side DU of the mobile IAB node 300M (the IAB-DU #1 of the mobile IAB node 300M in the example of FIG. 10A). The source side DU (source cell) then extracts the handover command from the F1 message and transmits the handover command to the UE 100.

In step S15, the UE 100 extracts the UL grant information and the like from the handover command, and transmits the RRC reconfiguration complete (RRCReconfigurationComplete) message to the target side DU (target cell) using the resources indicated by the UL grant information without performing a random access procedure. Thereby, the UE 100 performs an RACH-less handover. The UE 100 executes an RACH-less handover using the resources allocated by the target side DU.

### Example 1 According to First Embodiment

The operation example according to the first embodiment described above has been described mainly using an example of a case where the mobile IAB node 300M performs inter-donor migration, but is not limited thereto. The operation example described above is also applicable to a case where the mobile IAB node 300M performs intra-donor node migration (FIG. 12B). In this case, the CU of the donor node 200 may request the IAB-DU of the mobile IAB node 300M to secure resources (step S11). The LAB-DU of the mobile IAB node 300M transmits an UL grant for an RACH-less handover to the CU of the donor node 200 (step S12). Then, the CU of the donor node 200 transmits a handover command including the UL grant to the UE 100 (step S14).

The above-described operation example is also applicable to the inter-gNB handover (FIG. 13A). In this case, in FIG. 14, the source side DU can be read as the DU of the source side gNB 200-1, and the target side DU can be read as the DU of the target side gNB 200-2.

The above-described operation example is also applicable to the intra-gNB handover (FIG. 13B). In this case, in FIG. 14, the source side DU may be read as the source side DU of the gNB 200, and the target side DU may be read as the target side DU of the gNB 200.

The above-described operation example is also applicable to a case where the mobile IAB node 300M itself performs an RACH-less handover for the donor node 200.

First, when the mobile IAB node 300M performs inter-donor migration, the source side DU may be read as the DU of the source donor node 200-S, the target side DU may be read as the DU of the target donor node 200-T, and the UE 100 may be read as the mobile IAB node 300M in FIG. 14. In this case, in FIG. 14, the CU of the target donor node 200-T transmits the handover command to the CU of the source donor node 200-S using an Xn message, and the CU of the source donor node 200-S transmits the handover command to the mobile IAB node 300M.

Second, when the mobile IAB node 300M performs intra-donor migration, the source side DU may be read as the source side DU of the donor node 200, the target side DU may be read as the target side DU of the donor node 200, and the UE 100 may be read as the mobile IAB node 300M in FIG. 14. The operation example illustrated in FIG. 14 is also applicable to an intra-DU handover (intra-DU HO).

### Example 2 According to First Embodiment

In the first embodiment, an example of an RACH-less handover has been described, but the present disclosure is not limited thereto. For example, the first embodiment is also applicable to a case where a conditional handover (CHO) is performed as an RACH-less handover. In this case, the CU may request the target side DU to secure resources for the conditional RACH-less handover (step S11). The request may be made by a resource securing request message as in the first embodiment. The target side DU transmits UL grant information indicating the resources for the conditional RACH-less handover to the CU (step S12). The UL grant information may be included in a resource information message. The CU may include the UL grant information in a conditional reconfiguration and transmit an RRC reconfiguration (RRCReconfiguration) message including a conditional additional reconfiguration to the UE 100 (step S14).

### Second Embodiment

A second embodiment will be described. In the second embodiment, differences from the first embodiment will mainly be described.

In the second embodiment, an example of a case where a conditional handover is performed as an RACH-less handover will be described. In the following, a conditional handover performed as an RACH-less handover may be referred to as a conditional RACH-less handover (conditional RACH-less HO).

### Conditional Handover

Here, a conditional handover (CHO) is described. In a typical handover, UE 100 reports measurement values of radio states of a serving cell and/or neighboring cells to a gNB 200, and the gNB 200 determines a handover to the neighboring cells on the basis of this report and transmits a handover instruction to the UE 100. For this reason, when the radio state of the serving cell is rapidly degraded, communication disruption in the typical handover may occur before the handover is executed.

On the other hand, in the conditional handover, when a preset trigger condition is satisfied, the UE 100 can autonomously execute a handover to a candidate cell corresponding to the trigger condition. For this reason, problems with the typical handover such as communication disruption can be solved.

The conditional handover is configured by conditional reconfiguration. The conditional reconfiguration is one of information elements (IEs) included in an RRC reconfiguration (RRCReconfiguration) message. The conditional reconfiguration is configured, for example, by transmitting an RRC reconfiguration message from a CU of a donor node 200 to an IAB-MT of an IAB node 300 (or UE 100). The conditional reconfiguration includes candidate cells and execution conditions used in the conditional handover. The execution conditions include one or more trigger conditions. When the trigger conditions are satisfied, the IAB-MT of the IAB node 300 (or UE 100) starts executing a handover to the candidate cell.

### Communication Control Method According to Second Embodiment

As described above, for example, when the UE 100 performs a conditional handover, the UE 100 does not start accessing a target cell until a trigger condition is satisfied. That is, the UE 100 does not immediately start accessing the target cell after conditional reconfiguration is set. In a conditional handover, it is also possible to set access to a plurality of target cells. However, in some cases, a trigger condition is not satisfied for a certain target cell and the UE 100 does not access the cell.

Even in the case of a conditional RACH-less handover, when a trigger condition is satisfied, an RACH-less handover is executed, and thus resources (UL resources) for the execution is required. Specifically, resources (or radio resources) for transmitting an RRC reconfiguration complete (RRCReconfigurationComplete) message to a target cell is required.

As described above, in the conditional handover, the UE 100 does not immediately access the target cell. For this reason, the resources for transmitting the RRC reconfiguration complete message is secured for a certain period of time.

However, maintaining the resources for a certain period of time or longer may be considered to not be desirable from the perspective of resource efficiency. This is because, using the resources for other communications may be better than maintaining the resources for a certain period of time or longer.

An object of the second embodiment is to achieve the effective use of radio resources while securing resources for a conditional RACH-less handover.

For this reason, in the second embodiment, first, either one of transmission of validity period information indicating the validity period of resources used in a user equipment (for example, the UE 100) during the conditional RACH-less handover to a distributed unit (DU) by the central unit (CU), or transmission of the validity period information to the central unit by the distributed unit is performed. Second, the central unit transmits a conditional reconfiguration including the validity period information to the user equipment.

In this manner, the UE 100 is notified of the validity period of the resources used in the conditional RACH-less handover, and thus, when the validity period expires, the resources are released and can be used for other communications. Thus, a cellular communication system 1 can achieve the effective use of the resources while securing the resources for the conditional RACH-less handover.

As in the first embodiment, the central unit is a CU and the distributed unit is a DU. An example of a relationship between the CU, the DU, and the UE 100 is also the same as in the first embodiment.

### Operation Example According to Second Embodiment

An operation example according to the second embodiment will be described.

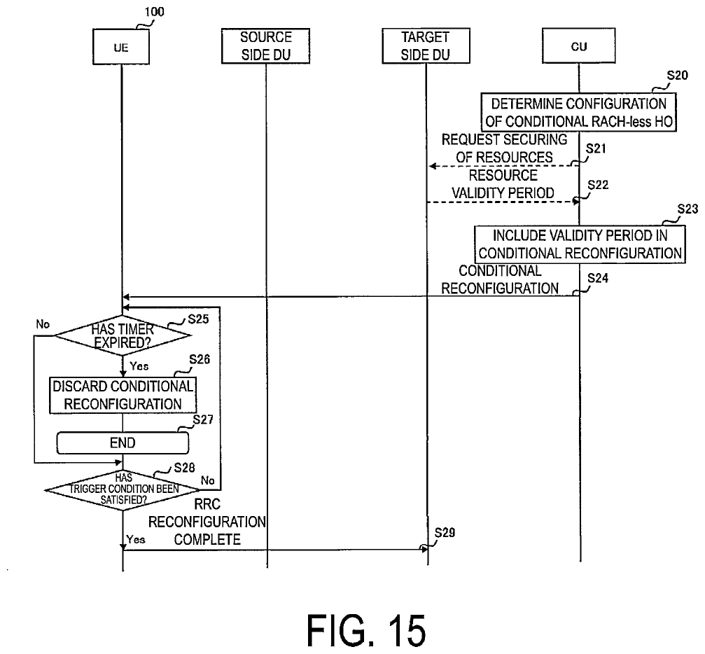

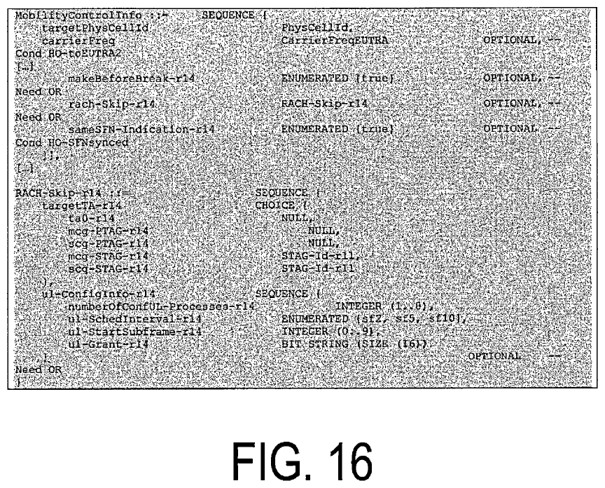

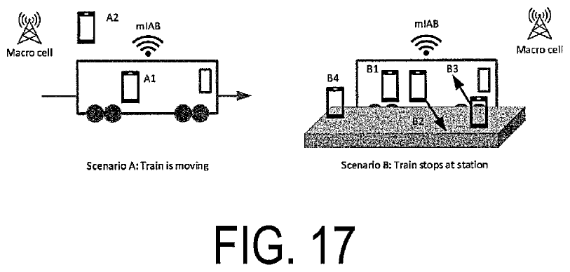

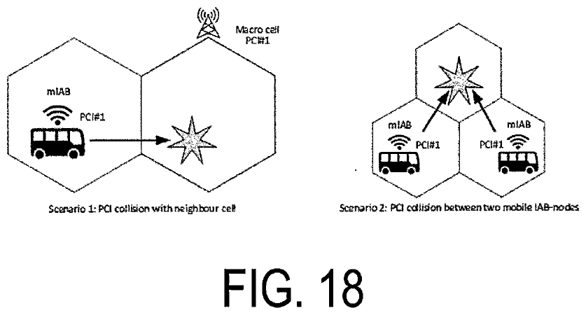

FIG. 15 is a diagram illustrating an operation example according to the second embodiment. The operation example illustrated in FIG. 15 will be mainly described using the example of inter-donor migration illustrated in FIG. 12A (or full migration illustrated in FIG. 9A to FIG. 10B).

As illustrated in FIG. 15, in step S20, the CU determines to configure a conditional RACH-less handover for the UE 100. For example, a CU of a target donor node 200-T determines to configure a conditional RACH-less handover for the UE 100 under the control of a mobile IAB node 300M.

In step S21, the CU may request the DU to secure resources (or UL resources) for the conditional RACH-less handover. As in the first embodiment, the request may be made using a resource securing request message. For example, when the CU of the target donor node 200-T has established an F1 connection with a target side DU (the IAB-DU #2 of the mobile IAB node 300M in the example of FIG. 10A), the CU transmits the resource securing request message to the target side DU as an F1 message. The resource securing request message may include validity period information indicating the validity period of the resources for the conditional RACH-less handover. The validity period may be represented by a timer value. The validity period may be determined by the CU.

In step S22, the DU may transmit, to the CU, resource information indicating the resources for the conditional RACH-less handover, together with the validity period information indicating the validity period of the resources. As in the first embodiment, the transmission may be performed using a resource information message. In this case, the resource information message includes the resource information and the validity period information. The validity period may be determined by the DU and transmitted to the CU. That is, the validity period may be determined by the CU (step S21). The validity period may be determined by the DU (step S22). For example, the target side DU (the IAB-DU #2 of the mobile IAB node 300M in the example of FIG. 10A) transmits a resource information message including the validity period information to the CU of the target donor node 200-T as an F1 message.

In step S23, the CU includes the validity period information in a conditional reconfiguration. The validity period may be associated with each conditional reconfiguration (or each entry in a configuration list). The validity period may be applied in common to all conditional reconfigurations. For example, the CU of the target donor node 200-T includes the validity period information in the conditional reconfiguration.

In step S24, the CU transmits a conditional reconfiguration including the validity period information to the UE 100. The conditional reconfiguration may be included in an RRC reconfiguration (RRCReconfiguration) message and transmitted. For example, the CU of the target donor node 200-T transmits the RRC reconfiguration message including the conditional reconfiguration to a CU of a source donor node 200-S using an Xn message, and the CU of the source donor node 200-S transmits the RRC reconfiguration message to the UE 100. In this case, the CU of the source donor node 200-S extracts the RRC reconfiguration message from the Xn message and transmits an F1 message including the RRC reconfiguration message to the source side DU of the mobile IAB node 300M (the IAB-DU #1 of the mobile IAB node 300M in the example of FIG. 10A). Then, the source side DU extracts the RRC reconfiguration message from the F1 message and transmits the RRC reconfiguration message to the UE 100.

In step S24, the UE 100 receives the conditional reconfiguration. When the conditional reconfiguration includes validity period information, the UE 100 starts counting with a timer. The UE 100 may start counting with the timer when it receives the conditional reconfiguration.

In step S25, the UE 100 determines whether the count value obtained by the timer has reached a validity period (that is, whether the timer has expired).

When the timer has expired (Yes in step S25), the UE 100 discards the conditional reconfiguration in step S26. That is, the UE 100 discards the conditional reconfiguration because the validity period of the resources for the conditional RACH-less handover has expired. Then, the UE 100 ends the series of processes in step S27.

On the other hand, when the trigger condition is satisfied (Yes in step S28) before the timer expires (No in step S25), the UE 100 transmits an RRC reconfiguration complete message to the target DU in step S29. That is, when the trigger condition indicated by the conditional reconfiguration is satisfied before the validity period expires, the UE 100 executes a conditional RACH-less handover by transmitting the RRC reconfiguration complete message to the target DU. On the other hand, when the trigger condition is not satisfied (No in step S28) before the timer expires (No in step S25), the UE 100 proceeds to step S25 and repeats the above-described processes (steps S25 to S28).

### Example 1 According to First Embodiment

The operation example according to the first embodiment has been described mainly using an example of a case where the mobile IAB node 300M performs inter-donor migration, but is not limited thereto. The operation example described above is also applicable to a case where the mobile IAB node 300M performs intra-donor node migration (FIG. 12B). In this case, the operation example can be implemented by replacing the target side DU and the source side DU in the same manner as in the first embodiment.

The operation example according to the first embodiment is also applicable to an inter-gNB handover (FIG. 13A). The operation example described above is also applicable to an intra-gNB handover (FIG. 13B). The operation example described above is also applicable when performing an RACH-less handover for the donor node 200 of the mobile IAB node 300M itself. In either case, the operation example can be implemented by replacing the CU, the target side DU, the source side DU, and/or the UE in the same manner as in the first embodiment.

### Example 2 According to Second Embodiment

For the validity period described in the second embodiment, a value predetermined in the specifications (or a value determined by hard coding) may be used. In this case, the validity period is not transmitted from the CU to the UE 100. When a conditional RACH-less handover is configured (step S24), the UE 100 starts counting with a timer and determines whether the timer has expired depending on whether the count value has reached a predetermined value.

### Example 3 According to Second Embodiment

In the second embodiment, an example where an RACH-less handover is performed in a conditional handover has been described, but the present disclosure is not limited thereto. For example, the present disclosure is also applicable to a case where an RACH-less handover is performed in another conditional cell change procedure. Other conditional cell change procedures include, for example, a conditional PS cell change (Conditional PSCell Change (CPC)) or a conditional PS cell addition (Conditional PSCell Addition (CPA)).

The conditional PS cell change is a procedure in which, for example, when an execution condition is satisfied, the UE 100 changes a PS cell that is a primary cell of a secondary cell group. The conditional PS cell change is configured by a CPC configuration. The CPC configuration includes an execution condition and information on candidate PS cells. The CU may transmit the CPC configuration to the UE 100 inclusive of validity period information (step S24) to configure an RACH-less handover in the conditional PS cell change in the UE 100. The UE 100 discards the CPC configuration when the timer expires, and executes a PS cell change by the RACH-less handover when the execution condition is satisfied before the timer expires.

The conditional PS cell addition is a procedure of adding a PS cell in the UE 100 when, for example, the PS cell addition condition is satisfied. The conditional PS cell addition is configured by a CPA configuration. The CPA configuration includes an execution condition and information on candidate PS cells. The CU may transmit the CPA configuration to the UE 100 inclusive of validity period information (step S23) to configure an RACH-less handover in the conditional PS cell addition in the UE 100. The UE 100 discards the CPA configuration when the timer expires, and executes a PS cell addition by the RACH-less handover when the execution condition is satisfied before the timer expires.

### Example 4 According to Second Embodiment

In the second embodiment, an example in which validity period information is configured in the UE 100 has been described, but the present disclosure is not limited thereto. The validity period may be used by the CU. The CU of the source donor node 200-S may be notified of the validity period by the CU of the target donor node 200-T via an Xn message. For example, the CU of the source donor node 200-S starts a timer in which the validity period is set when the conditional RACH-less handover is configured for the UE 100 (or when the configuration is received from the CU of the target donor node 200-T). The CU of the source donor node 200-S may remove the configuration of the RACH-less handover from the UE 100 when the timer expires (for example, when the count value of the timer reaches the validity period).

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily executed, and only some of the steps may be executed.

In the above-described embodiments and examples, an example in which the base station is an NR base station (gNB) has been described, but the base station may be an LTE base station (eNB) or a 6G base station. The base station may be a relay node such as an integrated access and backhaul (IAB) node. The base station may be a DU of the IAB node. The UE 100 may be a mobile termination (MT) of the IAB node.

The term “network node” mainly refers to a base station, but may also refer to a device of a core network or a part (a CU, a DU, or an RU) of a base station.

A program causing a computer to execute each of the processing performed by the UE 100 or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to,” unless specifically stated otherwise. The phrase “based on” means both “based only on” and “based at least in part on”. Similarly, the phrase “depending on/in response to” means both “only depending on/in response to” and “at least partially depending on/in response to”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### First Supplements

### Supplementary Note 1

A communication control method used in a cellular communication system, the communication control method including:
transmitting, by a distributed unit (DU) to a central unit (CU), resource information regarding a resource used in a user equipment during an RACH-less handover; and
transmitting, by the central unit to the user equipment, a handover command including the resource information.

### Supplementary Note 2

The communication control method according to supplementary note 1 further including transmitting, by the central unit to the distributed unit, a resource securing request message for requesting securing of the resource,
wherein the step of transmitting the resource information includes transmitting, by the distributed unit to the central unit, a resource information message including the resource information in response to reception of the resource securing request message.

### Supplementary Note 3

The communication control method according to supplementary note 1 or 2, wherein the central unit is included in a donor node, and the distributed unit is included in a mobile relay node.

### Supplementary Note 4

The communication control method according to any one of Appendices 1 to 3, wherein the central unit and the distributed unit are included in a network node (or a network device).

### Supplementary Note 5

The communication control method according to any one of Appendices 1 to 4, wherein the RACH-less handover is a conditional RACH-less handover.

### Supplementary Note 6

A communication control method used in a cellular communication system, the communication control method including:
either transmitting, by a central unit (CU) to a distributed unit (DU), validity period information indicating a validity period of a resource used in a user equipment during a conditional RACH-less handover, or transmitting, by the distributed unit to the central unit, the validity period information; and
transmitting, by the central unit to the user equipment, a conditional reconfiguration including the validity period information.

### Supplementary Note 7

The communication control method according to supplementary note 6, further including, by the user equipment, discarding the conditional reconfiguration when the validity period has expired, and executing an RACH-less handover when a trigger condition indicated in the conditional reconfiguration is satisfied before the validity period expires.

### Second Supplements

### Introduction

A WID related to a mobile IABs was revised in a RAN #97e with the following objectives. The detailed objectives of WI are as follows.
A mobility/topology adaptation procedure for realizing mobility of an IAB node, including inter-donor migration (full migration) of the entire mobile IAB node, is defined.
The mobile IAB node can connect to a fixed (intermediate) IAB node. Optimization specific to a scenario where a mobile IAB node is connected to a stationary (intermediate) IAB node or is directly connected to an IAB donor DU is not prioritized.
Mobility of a dual-connected IAB node is deprioritized.
Mobility of an IAB node and its UE, including aspects related to group mobility, is enhanced.
   No optimization for targeting surrounding UEs is performed.
   Note: Solutions should avoid touching on topics already discussed in Rel-17 or topics excluded from Rel-17, but IAB node mobility-specific enhancements are exceptional.
Mitigation of interference due to IAB node mobility, including avoidance of a potential collision between reference signal and control signal (PCI, RACH, and the like).
   The following principles should be respected.
A mobile IAB node should be able to provide a service to a legacy UE.
There is a possibility that solutions providing optimization for a mobile IAB may involve enhancements to a Rel-18UE.

One of main problems in Rel-18 is how to efficiently perform handovers of a plurality of descendant UEs during movement between mobile IAB nodes. In these appendices, details of mobility enhancement for a mobile IAB are described.

### Discussion

### RACH-Less Handover for Rel-18UE

A RAN2 #119e has reached the following agreement.

An R2 assumes that there is a possibility that an RACH-less procedure may be considered for an on-board RRC CONNECTED UE handed over with a mobile IAB node (also depends on assumption of UL synchronization).

In LTE, an RACH-less handover is configured as follows by using applicable timing advance (TA) and uplink grant (UL) information in MobilityControlInfo.

Regarding a TA value for UE in an RACH-less handover during an IAB node migration, source cell and target cell are provided via the same “physical” DU (but dual “logical” DU), and thus the UE is considered to apply the latest TA value in order to access the target cell. That is, a “physical” distance from the UE needs to be the same. Thus, there is no need for the UE to configure an explicit TA value. On the other hand, when an RACH-less handover is used for other scenarios, for example, a mobile IAB-MT handover, a generic approach like the LTE configuration is required.

Proposal 1: A RAN2 should discuss whether the UE should implicitly apply the latest TA value or explicitly configure the corresponding TA value for the RACH-less handover of the UE.

The UE needs to transmit an RRCReconfigurationComplete in UL resources given by the target cell, and thus UL grant information needs to be configured in the UE.

Proposal 2: The RAN2 should agree for the RACH-less handover of the UE that UL grant information is configured by a target IAB donor CU.

Considering an RRC IE structure of NR, it can be assumed that an RACH-less configuration is included in reconfigurationWithSync in CellGroupConfig because the RACH-less handover is indicated by the target IAB donor CU during a handover procedure.

Proposal 3: The RAN2 should agree that RACH-less handover is configured with a handover command (reconfiguration with synchronization).

One question is whether the RACH-less handover is also applicable to a conditional handover. The RAN2 #119e agreed that it would be useful to support a conditional RACH-less handover because “R2 assumes that a CHO or a delayed RRC configuration can be the baseline for group mobility.”

Proposal 4: The RAN2 should discuss whether the RACH-less handover can also be configured with a conditional handover (conditional reconfiguration).

### Handover Procedure of Legacy UE

The RAN2 #119e has reached the following agreement.

The R2 assumes that a CHO or a delayed RRC configuration (delayed RRC config) can be the baseline for group mobility (further study is required in a case applicable to IABMT mobility).

The WID makes it clear that a legacy UE should be provided by a mobile IAB node. The following principles should be respected.
A mobile IAB node should be able to provide a service to a legacy UE.
There is a possibility that solutions providing optimization for a mobile IAB may involve enhancements to the Rel-18UE.

A conditional handover (CHO) was introduced in Rel-16, and thus a Rel-15UE does not support a conditional reconfiguration function. For this reason, the CHO cannot be the baseline for group mobility during the migration of the mobile IAB node. A handover command of the related art is use as the baseline, and a CHO should provide some enhancements for efficient group mobility of UEs after Rel-16.

Observation 1: A conditional handover was introduced in Rel-16, but a mobile IAB node should also support the Rel-15UE. For this reason, the handover command of the related art is the only method for controlling the mobility of the Rel-15UE.

Regarding the handover command of the related art, the RAN2 agreed on “delayed RRC config” as one of the candidates. However, it is not clear whether this “delayedRRCconfig” is intended to be the same as a deferred/conditional delivery of an RRC reconfiguration message specified in Rel-17, that is, solution 1. When it is the deferred/conditional delivery, it will work in legacy UEs including the Rel-15UE. Otherwise, there is a possibility that it may not work depending on an intended solution(s). For this reason, the RAN2 needs to clarify what is intended by the “delayed RRC configuration (delayed RRC config)”.

Proposal 5: The RAN2 should clarify whether the deferred/conditional delivery of the RRC messages specified in Rel-17 is the same as the “delayed RRC config” agreed in the previous meeting.

The RAN2 #119e supported the following points.
P3: Regarding “dual-DU-way” for performing full migration, the RAN2 can discuss whether the legacy UE should consider two logical cells/DUs as separate physical cells or the same physical cell, and in which case, what procedures the legacy UE needs to execute.

A handover to the same PCI may be possible from the perspective of signaling, but it is unclear whether there is a risk of the UE making any errors.

When a CHO is used for the Rel-16 UE, that is, there is only A3/A5-based trigger, the condition cannot be satisfied because there is a possibility that the UE may perceive RSRP from the source cell and RSRP from the target cell to be the same when these PCIs are the same.

When the PCI needs to be changed during the migration of the mobile IAB node, that is, in order to avoid a PCI collision, the PCI of the target cell needs to be different from the PCI of the source cell.

That is, even when the source cell and target cell are “physically” provided by the same IAB node, the PCIs will be different from each other.

Proposal 6: The RAN2 should assume that two logical cells/DUs have different PCIs.

### Cell Reselection of Rel-18UE

The RAN2 #119e supported the following points.
P1: The RAN2 discusses scenarios to enhance cell (re) selection between mobile IAB nodes, for example, based on broadcast parameters of the mobile IAB nodes.

Two main scenarios and several subcases are considered as follows.
Scenario A: A mobile IAB node is moving together with a camped UE.
Subcase A1: A UE (a train or the like) needs to stay on the mobile IAB node.
Subcase A2: Surrounding UEs (the outside of the train) should not camp on the mobile IAB node.
Scenario B: The mobile IAB node is stationary together with the camped UE.
Subcase B1: The UE (for example, still on the train) stays on the mobile IAB node.
Subcase B2: The UE (for example, getting off the train) needs to reselect a fixed cell (for example, a macro cell).
Subcase B3: Surrounding UEs (for example, getting on the train) need to reselect a mobile IAB node.
Subcase B4: Surrounding UEs (for example, still at a station) should stay on their fixed cells.

The subcases A2, B3, and B4 are actions desirable for the surrounding UEs. However, the WID specifies that there are no optimizations targeting the surrounding UEs. For the subcase B3, the UE enters the subcase B1 or B2 after getting on the train, but the initial state of the UE remains in the state of the surrounding UE. Thus, these subcases are excluded from targets.

Mobility of an IAB node and its UE, including aspects related to group mobility, is enhanced. No optimization for targeting surrounding UEs is performed.

Observation 2: Optimization targeting the surrounding UEs is outside the scope of WI.

In a subcase A1, UE moves together with a mobile IAB node. For this reason, RSRP and RSRQ from the mobile IAB node are always stable and sufficiently good. For example, a mobile IAB node broadcasts the frequency priority of the mobile IAB node itself as “7” or broadcasts the cell of the mobile IAB node itself as an HSDN cell.

A train has a plurality of vehicles and a mobile IAB node is considered to be deployed in each vehicle. Even when UE moves between the vehicles, one of the cells of the mobile IAB node is always more stable than an external macro cell from the perspective of the UE in the train. As a typical case, it is assumed that the mobile IAB node cells operate on the same frequency. In this case, the existing intra-frequency cell reselection, that is, R-criterion, functions appropriately.

For this reason, the existing radio condition-based cell reselection functions well and does not need to be augmented using, for example, some broadcast information.

Observation 3: A UE moving together with an IAB node can stay on an IAB node based on the existing radio condition-based cell reselection and appropriate frequency priority.

In the case of the subcases B1 and B2, there is no method for an AS to grasp whether a user will stay on the train or leave the train. In this case, even when a mobile IAB node broadcasts some information, UE cannot determine which cell (mobile IAB node or fixed macro cell) should be reselected finally. For this reason, which cell the UE should reselect finally depends on a radio condition and a frequency priority.

Observation 4: When UE and a mobile IAB node are stopped, the UE cannot determine whether to reselect a mobile IAB node unless the UE grasps a user's intention.

In summary, the existing cell reselection mechanism, that is, a cell reselection mechanism based on a radio condition and a frequency priority, still functions well. For this reason, no enhancement is required for the UE to execute cell reselection.

HSDN is useful for the subcase A1 because it can be supported by the mobile IAB node without specification changes.

Proposal 7: The RAN2 should agree that no enhancement is required for the UE to execute cell reselection between the mobile IAB node and the UE.

### Mobile IAB Node Indication

The RAN2 #119e supported the following points.
P2: It can be discussed whether a mobile IAB-MT needs to transmit a mobile IAB indication (capability or mobility) to an IAB donor CU.

In a RAN3 #117e, the following agreement was made.

A donor CU should grasp that IAB nodes are “mobile”.

In a Rel-16 IAB, an IAB Node Indication is transmitted via a Msg5, which is intended for use by a donor to select an AMF that supports an IAB. Thus, one of the points is whether to transmit the mobile IAB Node Indication via the Msg5 depending on whether the donor needs to select the AMF supporting he mobile IAB, which is up to the RAN3.

It has been noted that the donor CU can acquire a real-time mobility status through the existing measurement report such as ImmediateMDT. Such mobility status information is considered to be useful for predictive mobility control. A reporter clarified that the mobile IAB node indication is necessary for the donor to configure the mobile IAB node with appropriate measurement settings.

Thus, the mobile IAB node indication should be transmitted by IAB-MT at least from the perspective of AS. However, it is unclear whether such an indication needs to be transmitted via the Msg5 or by Capability signaling, which is up to the RAN3.

Proposal 8: The RAN2 should agree that the mobile IAB node indication is transmitted by an RRC message. It is up to the RAN3 whether the RRC message is the Msg5 or the Capability signaling.

### Access Restriction of Mobile IAB Node

In the WID, mobile IAB nodes provide services only to UEs.
The mobile IAB nodes do not have descendant IAB nodes and provide services only to UEs.

To secure this requirement, the RAN2 #119e has agreed as follows.
A method of not broadcasting the IAB support indication is sufficient to prevent other IAB nodes from accessing the mobile IAB (without further influence on the specification).

Regarding the part “(without further influence on the specification)”, it is questionable whether it is really sufficient to leave it to the implementation. Since the WID clearly requires that a mobile IAB node cannot access other mobile IAB nodes, the clarification of this premise in the specification is considered to be necessary in order to avoid confusion in mobile IAB implementations. For this reason, it is desirable for the Stage-2 specification to either adopt the above-described agreement or clarify that “a mobile IAB node cannot access other mobile IAB nodes in this release.”

Proposal 9: The RAN2 should agree to include, in the Stage-2 specifications, not configuring an IAB support IE in an SIB when an IAB node operates as a mobile IAB node in this release.

### Introduction

The WID related to a mobile IAB was revised in the RAN #97e with the following objectives. The detailed objectives of WI are as follows.
A mobility/topology adaptation procedure for realizing mobility of an IAB node, including inter-donor migration (full migration) of the entire mobile IAB node, is defined.
The mobile IAB node can connect to a fixed (intermediate) IAB node. Optimization specific to a scenario where a mobile IAB node is connected to a stationary (intermediate) IAB node or is directly connected to an IAB donor DU is not prioritized.
Mobility of a dual-connected IAB node is deprioritized.
Mobility of an IAB node and its UE, including aspects related to group mobility, is enhanced.
   No optimization for targeting surrounding UEs is performed.
   Note: Solutions should avoid touching on topics already discussed in Rel-17 or topics excluded from Rel-17, but IAB node mobility-specific enhancements are exceptional.
Mitigation of interference due to IAB node mobility, including avoidance of a potential collision between reference signal and control signal (PCI, RACH, and the like).
   The following principles should be respected:
A mobile IAB node should be able to provide a service to a legacy UE.
There is a possibility that solutions providing optimization for a mobile IAB may involve enhancements to a Rel-18UE.

One of the objectives is to mitigate interference due to IAB node mobility. In these appendices, potential problems regarding PCI collisions and RACH configuration collisions are discussed.

### Discussion

### Dynamic PCI Change Mechanism

The RAN2 #119e supported the following points.
P4: The RAN2 may discuss whether there are any PCI partitioning problems that need to/can be addressed (for use in application scenarios) when found within the scope of the R2. From the perspective of the R2, the need and feasibility of a dynamic PCI change mechanism may be discussed. It is discussed whether enhancements to the current UE/MT reporting are useful/necessary to improve PCI collision detection.

Two scenarios of a PCI collision are considered as follows.
Scenario 1: A PCI of a mobile IAB node collides with a neighboring cell.
Scenario 2: PCIs of two mobile IAB nodes that move to the same target donor collide with each other.

In the scenario 1, when a PCI space for fixed cells (macro cells or the like) and a PCI space for mobile IAB-nodes are separated from each other, the existing PCI partitioning may function. However, there are also cases where a small PCI space can be a problem, such as insufficient PCIs in an area with a large number of small cells.

In the scenario 2, when PCI partitioning is used, the PCI space for the mobile IAB nodes may need to be further separated or a global PCI (that is, not reusable in a PLMN) may need to be assigned to each IAB node. Considering that the number of PCIs is limited, the PCI partitioning is not a practical solution.

Especially in the scenario 2, a dynamic PCI change mechanism is required.

Proposal 1: The RAN2 should agree that a dynamic PCI change mechanism is required particularly when a PCI collision occurs between two mobile IAB nodes.

Three approaches are considered for PCI collision avoidance: IAB-MT measurement, UE reporting, and network coordination.

In the IAB-MT measurement, when a mobile IAB node detects the same PCI from a neighboring cell, the mobile IAB node is considered to change its own PCI. However, a PCI collision has already occurred at a point in time when the IAB-MT detects the same PCI.

In the UE reporting, when UE detects and reports the same PCI from a different cell, a donor is considered to request the mobile IAB node to change its PCI. However, it is questionable whether UE can determine whether the different cells use the same PCI. Similarly, there is also a possibility that a PCI collision has already occurred at a point in time when the UE detects the same PCI.

In the network coordination, a source donor is considered to inquire a target donor whether a PCI used by a migrating mobile IAB node is acceptable during the migration of the mobile IAB node. In order to avoid future PCI collisions, the target donor is considered to ask the same to nearby gNBs, for example, whether another mobile IAB node in the vicinity of the target donor uses the same PCI. With this approach, PCI collisions can be avoided in advance. Thus, the RAN2 should consider that dynamic PCI changes occur only during the movement of the mobile IAB node, and there is no enhancement from the perspective of the RAN2. It is up to the RAN3 how the RAN3 avoids and changes PCI collisions during the migration of the mobile IAB node.

Proposal 2: The RAN2 needs to assume that dynamic PCI changes occur only during IAB node migration procedures and that PCI collisions will be resolved by network coordination. It is up to the RAN3, not the RAN2, how to avoid PCI collisions.

### Collision of RACH Configuration

The RAN2 #119e supported the following points.
P5: The RAN2 can discuss whether there is a problem of an RACH configuration collision between a mobile IAB and a fixed network from the perspective of the RAN2 and/or whether the RAN2 should request the RAN1 to consider RAN1-related aspects.

When two nearby cells use the same PRACH configuration, there is a possibility that a problem of an increased PRACH collision rate will occur. There is a possibility that an incorrect RAR will also be a risk. For example, even though UE transmits a PRACH to a cell A, it is also received by a cell B, and the UE may receive an RAR from the cell B. When the RAN2 specifies these possible problems, the RAN2 needs to request a further analysis from the RAN1.

Observation 1: The RAN1 is a group suitable for analyzing a collision problem of an RACH configuration.

1. A communication control method used in a user equipment, the communication control method comprising:
receiving, by a user equipment, information configuring resources for performing a RACH (Random Access Channel)-less handover from a cell of a source DU (Distribution Unit) of a mobile IAB (Integrated Access and Backhaul) node to a cell of a target DU; and
transmitting, by the user equipment, an RRC message to the cell of the target DU using the resource information without performing a random access procedure, wherein
the source DU is F1-connected to a CU of the source donor node, and the target DU is F1-connected to a CU of a target donor node.

2. The communication control method according to claim 1, wherein
the information configuring the resources is included in an RRC reconfiguration message,
transmitting the RRC message includes transmitting an RRC reconfiguration complete message.

3. The communication method of claim 1, further comprising:
transmitting to the target DU of the mobile IAB node, by the CU of the target donor node, a UE context setup request message;
receiving from the target DU of the mobile IAB node, by the CU of the target donor node, an F1 message for the UE context setup request message; and
transmitting to the user equipment, by the CU of the target donor node, the resource information included in the F1 message.

4. A user equipment comprising:
a receiver configured to receive information configuring resources for performing a RACH (Random Access Channel)-less handover from a cell of a source DU (Distribution Unit) of a mobile IAB (Integrated Access and Backhaul) node to a cell of a target DU, and
a transmitter configured to transmit an RRC message to the cell of the target DU using the resource information without performing a random access procedure, wherein
the source DU is F1-connected to a CU of the source donor node, and the target DU is F1-connected to a CU of a target donor node.

5. A chipset for a user equipment, the chipset configured to execute processes of:
receiving information configuring resources for performing a RACH (Random Access Channel)-less handover from a cell of a source DU (Distribution Unit) of a mobile IAB (Integrated Access and Backhaul) node to a cell of a target DU; and
transmitting an RRC message to the cell of the target DU using the resource information without performing a random access procedure, wherein
the source DU is F1-connected to a CU of the source donor node, and the target DU is F1-connected to a CU of a target donor node.

6. A non-transitory computer-readable medium comprising, stored thereupon, computer program instructions for execution by a user equipment, the program instructions being configured to cause the user equipment to execute processes of:
receiving information configuring resources for performing a RACH (Random Access Channel)-less handover from a cell of a source DU (Distribution Unit) of a mobile IAB (Integrated Access and Backhaul) node to a cell of a target DU; and
transmitting an RRC message to the cell of the target DU using the resource information without performing a random access procedure, wherein
the source DU is F1-connected to a CU of the source donor node, and the target DU is F1-connected to a CU of a target donor node.

7. A system comprising:
a user equipment, and
a mobile IAB (Integrated Access and Backhaul) node, wherein
the user equipment is configured to receive information configuring resources for performing a RACH (Random Access Channel)-less handover from a cell of a source DU (Distribution Unit) of a mobile IAB (Integrated Access and Backhaul) node to a cell of a target DU, and
the user equipment is configured to transmit an RRC message to the cell of the target DU using the resource information without performing a random access procedure, wherein
the source DU is F1-connected to a CU of the source donor node, and the target DU is F1-connected to a CU of a target donor node.
